(19) United States
(12) Patent Application Publication
(10) Pub. No.: US 2019/0190609 A1
(43) Pub. Date: Jun. 20, 2019

(54) Optical Transceiver for Radio Frequency Communication

(71) Applicant: Qualcomm Incorporated, San Diego, CA (US)

(72) Inventor: Udara Fernando, San Diego, CA (US)

(21) Appl. No.: 15/844,483

(22) Filed: Dec. 15, 2017

(51) Int. Cl. H04B 10/43; H01Q 5/22; H04B 10/80; H01Q 1/38

(52) U.S. Cl. CPC H04B 10/43; H01Q 5/22; H04B 10/504; H01Q 1/38; H04B 10/802

(57) ABSTRACT

An apparatus is disclosed that implements an optical transceiver for radio frequency (RF) communication. In an example aspect, the apparatus includes an antenna array, a fiber optic cable, and a radio frequency integrated circuit (RFIC) that is coupled to the antenna array and configured to receive an RF signal from the antenna array. The RFIC includes a light-emitting device disposed on a surface of the light emitting device. The light-emitting device is configured to emit an optical signal that is modulated responsive to the RF signal and to direct the modulated optical signal to the fiber optic cable so as to cause the modulated optical signal to propagate along the fiber optic cable.

### TECHNICAL FIELD

This disclosure relates generally to electronic communications and, more specifically, to reducing power consumption and electromagnetic interference in radio frequency communication devices (e.g., millimeter-wave radio frequency communication devices) by using an optical transceiver.

### BACKGROUND

Electronic devices play a crucial role in many aspects of modern society. In many cases, they are our primary computing platform and provide communication, entertainment, social media, email, calendar, and many other services that we use in our daily work and personal lives. Electronic devices are not merely our smartphones, for they are integrated in our cars, our televisions, and even our homes.

Electronic devices with wireless capabilities provide increased versatility. Historically, wireless devices were primarily used with analog cellular networks, which are good for voice communications, but are expensive to use. The development of digital networks reduced costs and allowed data communications in addition to voice calling. Higher-frequency digital networks (e.g., 3G and 4G) provided the capability to transmit more data and provide more services (e.g., smartphones that can deliver messaging, voice, video, and support applications such as social media, navigation, and so forth).

In today's interconnected world, the services provided by wireless electronic devices rely on ever-increasing amounts of data to deliver the best experiences. For example, virtual reality, on-demand video, self-driving vehicles, and technology for the internet-of-things transmit and receive vast amounts of data. More data requires faster data-transfer rates (bandwidth). Radio waves in the extremely high frequency (EHF) range have frequencies between approximately 25 gigahertz (GHz) and approximately 300 GHz. Radio waves in this range, also known as millimeter-wave (mmW) frequencies, can support data rates up to 10 gigabits per second, which is much higher than conventional radio frequency (RF) limits (e.g., a 4G cellular radio network is limited to about 1 gigabit per second).

Although more bandwidth is made available by using higher-frequency RF signals such as mmW RF signals, the devices that communicate over these frequencies use more power and suffer from increased electromagnetic (EM) interference. Consequently, engineers designing these devices are working to improve power efficiency and EM performance for EHF signals to enable increased bandwidth and more services to be provided to users.

### SUMMARY

An optical transceiver for radio frequency communication is disclosed herein. Example implementations of the disclosed optical transceiver for radio frequency communication can consume less power, emit less electromagnetic radiation, and have a reduced component count, while being used to facilitate higher-bandwidth radio frequency communication.

In an example aspect, an apparatus is disclosed. The apparatus includes an antenna array, a radio frequency integrated circuit (RFIC), and a baseband integrated circuit that includes a light-receiving device. The RFIC is coupled to the antenna array and mounted to a printed circuit board (PCB). The RFIC includes a surface that faces the PCB. The RFIC is configured to receive a radio frequency (RF) signal from the antenna array. The apparatus additionally includes a fiber optic cable that has a first end disposed proximate to the RFIC and a second end disposed proximate to the light-receiving device. At least a portion of the fiber optic cable is secured to the PCB. A light-emitting device is disposed on the surface that faces the PCB, and the light-emitting device is configured to emit an optical signal that is modulated responsive to the RF signal. The light-emitting device is further configured to direct the modulated optical signal to the first end of the fiber optic cable so as to cause the modulated optical signal to propagate along the fiber optic cable to be received by the light receiving device.

In an example aspect, an apparatus is disclosed. The apparatus includes an antenna array, a printed circuit board (PCB), a fiber optic cable, and a radio frequency integrated circuit (RFIC) that is coupled to the antenna array. The RFIC is mounted to the PCB, and the RFIC includes a surface that faces the PCB. At least a portion of the fiber optic cable is secured to the PCB. The RFIC is configured to receive a radio frequency (RF) signal from the antenna array. The RFIC includes a light-emitting device disposed on the surface that faces the PCB. The light emitting device is configured to emit an optical signal that is modulated responsive to the RF signal and direct the modulated optical signal to the fiber optic cable to propagate along the fiber optic cable.

In an example aspect, a method for operating an optical transceiver for radio frequency communication is disclosed. The method includes receiving an RF signal via an antenna array. The method also includes routing the RF signal from the antenna array to a radio frequency integrated circuit (RFIC) that is electrically connected to a light-emitting device. The method additionally includes converting, using the light emitting device, the RF signal to an analog optical signal. The method further includes directing the analog optical signal from the light-emitting device to a fiber optic cable such that the analog optical signal propagates along the fiber optic cable.

In an example aspect, an apparatus is disclosed. The apparatus includes a printed circuit board (PCB), an antenna array mounted to the PCB, and a fiber optic cable, with at least a portion of the fiber optic cable secured to the PCB. The apparatus also includes a radio frequency integrated circuit (RFIC) mounted to the PCB and coupled to the antenna array. The RFIC includes a surface that faces the PCB. The RFIC also includes a light-emitting device that is disposed on the surface that faces the PCB. The RFIC is configured to receive a radio frequency (RF) signal from the antenna array and to emit an optical signal that is modulated responsive to the RF signal. The apparatus further includes means for coupling the modulated optical signal between the light-emitting device and the fiber optic cable in a manner that causes the modulated optical signal to propagate along the fiber optic cable.

### BRIEF DESCRIPTION OF DRAWINGS

FIG. 1 illustrates an example environment that includes an electronic device in which an optical transceiver for radio frequency communication can be implemented.

FIG. 2 illustrates a conventional mmW radio frequency system as a simplified block diagram.

FIG. 3A illustrates, as a simplified block diagram, an example radio frequency communication system that includes an optical transceiver for radio frequency communication as described herein.

FIG. 3B illustrates an example implementation of an optical transceiver for radio frequency communication.

FIG. 4 illustrates additional details of the example implementation of the optical transceiver for radio frequency communication shown in FIG. 3B.

FIG. 5 illustrates an example of circuitry for implementation of an optical transceiver for radio frequency communication.

FIG. 6 is a flow diagram illustrating an example process for operating an optical transceiver for radio frequency communication.

FIG. 7 is a flow diagram that illustrates additional details of the example process shown in FIG. 6.

FIG. 8 illustrates an example electronic device that includes one or more integrated circuits in which an optical transceiver for radio frequency communication can be implemented.

### DETAILED DESCRIPTION

Radio frequency (RF) communication is based on using RF signals to transmit data. Electronic devices typically use government-assigned frequency bands of the electromagnetic (EM) spectrum, such as from about 500 KHz up to about 25 gigahertz (GHz), to transmit data and ensure compatibility between devices. These frequencies have a finite capacity to transmit data. As more devices communicate at particular frequencies, and as each device transmits more data, the various frequencies are approaching their maximum capacity. Thus, developing the ability to transmit data over additional ranges of the spectrum at higher frequencies is becoming more important to support our connected and data-driven economy and society.

Using higher-frequency ranges of the spectrum, however, has proven difficult because, historically, there were few devices that could transmit or receive mmW signals, which correspond to frequencies of 30-300 GHz. While there are more devices with mmW capability today, these devices are typically more expensive because they consume more power and because the higher frequencies require additional components and countermeasures to address EM interference. As the technology for antennas, transceivers, and integrated circuits that can receive, process, and transmit mmW signals has become more common, addressing the challenges related to cost has become more urgent.

With respect to integrated circuits, for example, the cost decreases as the total size of the circuit decreases. Consequently, the cost of integrated circuit chips, along with the electronic devices that use them, has been reduced over time. Unfortunately, the ability to rely on new manufacturing technologies to significantly shrink the size of the building blocks of circuits is becoming more difficult. However, there are alternative approaches to reducing the size and power usage of electronic circuitry. For example, the number of components used to implement a given functionality can be lowered. Example implementations that are described herein enable electronic devices to take advantage of the bandwidth provided by mmW radio frequency communication while reducing the power consumption and component cost usually associated with this technology.

Conventional mmW systems include one or more antenna modules that are coupled to a radio frequency integrated circuit (RFIC). The RFIC is connected to a baseband integrated circuit (BBIC) that includes a baseband modem. The RFIC and BBIC are connected via an intermediate frequency (IF) circuit that converts an IF signal to an analog BB signal, after the RFIC has converted the mmW signal to the IF signal. The RFIC is connected to the IF circuit via an IF cable that is typically inefficient with respect to power consumption and can be problematic with respect to stray EM emissions. In other words, existing IF cables usually consume appreciable levels of power while also producing EM radiation that interferes with the operation of other components. Additionally, designing the RFIC to accommodate the IF cable adds additional complexity to the system because multiple signals are generally multiplexed on the same IF cable, which further increases power usage.

In contrast, implementations that are described herein enable electronic devices that operate using mmW signals with reduced power consumption, reduced component count, and improved EM radiation emission. In an example approach, an RFIC includes an optical transceiver that converts an RF signal from at least one antenna module into an analog optical signal and transmits the analog optical signal to the BBIC (and the baseband modem) via a fiber optic cable. The optical transceiver may comprise an optical transmitter, an optical receiver, or both.

The RFIC includes a light-emitting device, such as a light-emitting diode (LED), that performs the signal conversion from RF signal to optical signal. The LED can be disposed on a side of the RFIC that is connected to a printed circuit board (PCB). Thus, the LED can emit the optical signal into a fiber optic cable secured to (e.g., adhered to or embedded in) the PCB. In an example arrangement, the fiber optic cable is effectively sandwiched between the RFIC and the PCB (e.g., the LED may be integrated into the underside of an RFIC in a flip-chip configuration).

Further, the RFIC and the LED are fabricated so that the LED provides the optical signal to the fiber optic cable in a manner that enables propagation of the signal along the fiber optic cable (e.g., within a range of angles of incidence that enable propagation). For example, the LED can be sufficiently close to a prepared, first end of the fiber optic cable to direct light from the LED to the first end of the fiber optic cable across a through-the-air connection (e.g., an air gap). Because the RFIC and the modem are typically manufactured or installed to be relatively close together (e.g., within a few meters of each other), losses resulting from an air gap between the LED and the first end of the fiber optic cable are acceptable. The system can then transmit the analog optical signal to the BBIC via the fiber optic cable. The fiber optic cable has a prepared, second end that is proximate to a light-receiving device of the BBIC, such as an optical diode. The light-receiving device is configured to convert the analog optical signal to an electrical signal. The BBIC can then downconvert from the mmW signal directly to a BB frequency, without using IF circuitry.

These implementations reduce the complexity of the circuitry used to convert a mmW signal to a BB signal by lowering the number of components employed for mmW communications, while also reducing power consumption. Using an analog optical signal also obviates the need to include analog-to-digital conversion circuitry at each antenna module, and antenna modules are replicated at multiple locations in a given device for mmW communications. Further, using a fiber optic cable instead of an IF cable saves power and reduces the potential for EM interference. Because of the relatively short distances in typical applications, there is little significant performance degradation.

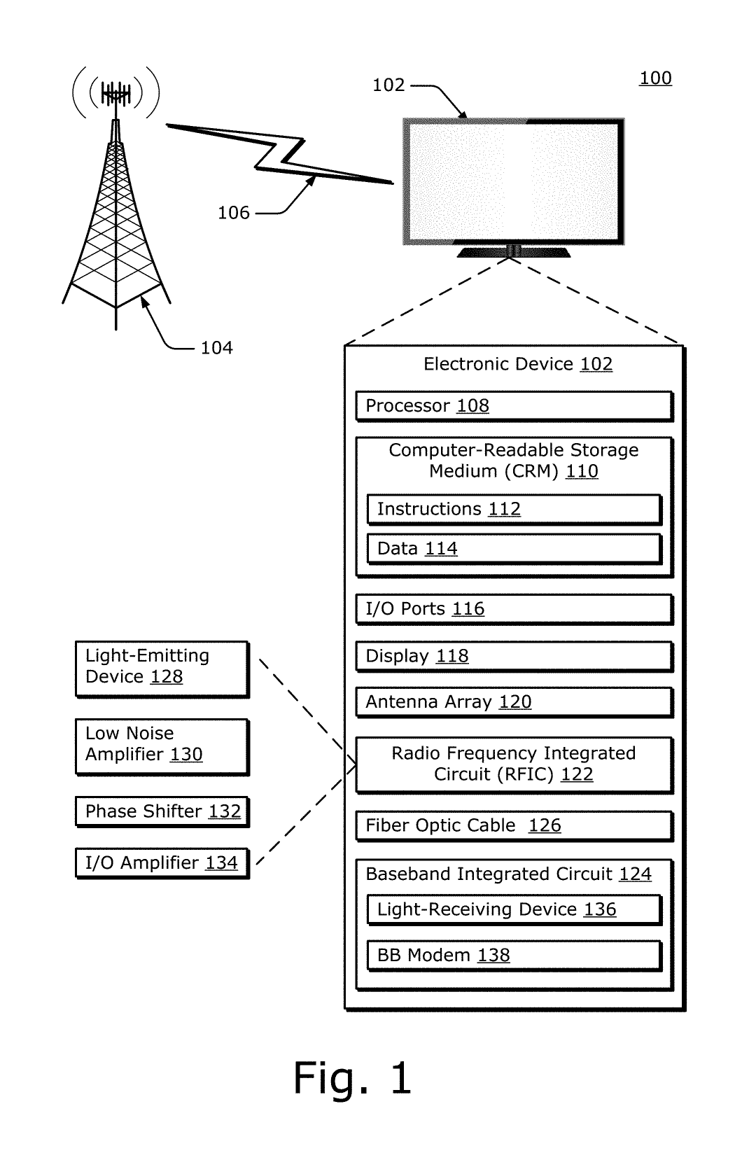

FIG. 1 illustrates an example environment 100 that includes an electronic device 102 in which an optical transceiver for radio frequency communication can be implemented. The electronic device 102 communicates with a base station 104 through a radio frequency (RF) communication link 106 (RF signal 106). The RF signal 106 may be, for example, a mmW radio frequency signal. In this example, the electronic device 102 is implemented as a display device. However, the electronic device 102 may be implemented as any suitable computing or other electronic device, such as a modem, cellular base station, broadband router, access point, cellular phone (e.g., a smart phone), gaming device, navigation device, media device (e.g., a television), laptop computer, desktop computer, tablet computer, server, network-attached storage (NAS) device, smart appliance, vehicle, vehicle-based communication system, and/or an Internet-of-Things (IoTs) device.

The base station 104 communicates with the electronic device 102 via the mmW signal 106, which may be implemented at any of a variety of suitable frequencies (e.g., 28 GHz, 39 GHz, 60 GHz, or 90 GHz). Although depicted as a base station tower of a cellular radio network, the base station 104 may represent or be implemented as any of a variety of mmW-capable devices, such as a satellite, cable television head-end, terrestrial television broadcast tower, access point, peer-to-peer device, set-top box, mesh network node, and/or GPS transceiver. Hence, the electronic device 102 may communicate with the base station 104 or another device via a wired connection, a wireless connection, or a combination thereof.

The RF signal 106 can include a downlink of data or control information communicated from the base station 104 to the electronic device 102 and an uplink of other data or control information communicated from the electronic device 102 to the base station 104. The RF signal 106 may be implemented using any suitable communication protocol or standard, such as 5G, WirelessHD, WirelessHD v1.1, IEEE 802.11ad, automotive radar (short-, medium-, and/or long-range), vehicle-to-infrastructure communication (V2I), and/or vehicle-to-vehicle communication (V2V).

The electronic device 102 includes a processor 108 and at least one computer-readable storage medium 110 (CRM 110). The processor 108 may include any type of processor, such as an application processor or multi-core processor, that is configured to execute processor-executable instructions (e.g., code) stored by the CRM 110. The CRM 110 may include any suitable type of data storage media, such as volatile memory (e.g., random access memory (RAM)), non-volatile memory (e.g., Flash memory), optical media, magnetic media (e.g., disk or tape), and so forth. In the context of this disclosure, the CRM 110 is implemented to store instructions 112, data 114, and other information of the electronic device 102, and thus does not include transitory propagating signals or carrier waves.

The electronic device 102 may also include input/output ports 116 (I/O ports 116) and/or a display 118 (as shown). The I/O ports 116 enable data exchanges or interaction with other devices, networks, or users. The I/O ports 116 may include serial ports (e.g., universal serial bus (USB) ports), parallel ports, audio ports, infrared (IR) ports, and so forth. The display 118 presents graphics of the electronic device 102, such as a user interface associated with an operating system, program, or application. Alternatively or additionally, the display 118 may be implemented as a display port or virtual interface through which graphical content of the electronic device 102 is communicated or presented.

The electronic device 102 also includes at least one antenna array 120, at least one radio frequency integrated circuit (RFIC) 122, and at least one baseband integrated circuit (BBIC) 124. The antenna array 120 can include multiple antenna elements per array, which may be arranged in subarrays. The antenna array 120 is communicatively coupled with the RFIC 122 and may be implemented as any of a variety of suitable active or passive antenna arrays that are capable of transmitting and receiving RF signals (including mmW signals), such as planar arrays, linear arrays, patch arrays, micro-strip arrays, and/or hybrid arrays. The antenna array 120 provides connectivity to respective networks and other electronic devices connected to those networks.

The RFIC 122 and the BBIC 124 are communicatively coupled one to another at least via a fiber optic cable 126. The fiber optic cable 126 includes at least one optical fiber, which can be either multi-mode or single-mode. The optical fiber may be made from a variety of materials, such as glass, plastic, or plastic-clad silica (PCS), and may have different cross sectional shapes, such as circular, square, rectangular, and so forth.

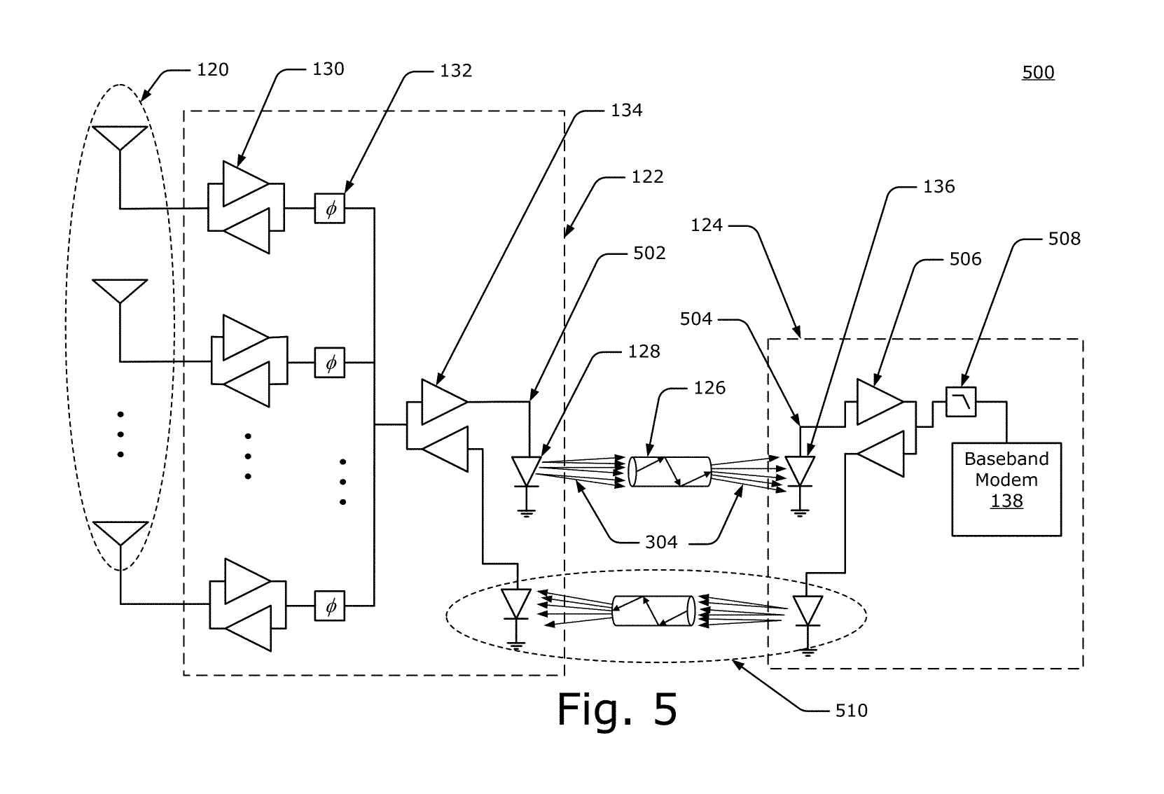

The RFIC 122 includes at least one light-emitting device 128 and, for respective antenna elements of the antenna array 120, a low-noise amplifier (LNA) 130, a phase shifter 132, and an input/output power amplifier 134 (I/O amplifier 134). Additional details of the LNA 130, the phase shifter 132, and the I/O amplifier 134 are described with reference to FIG. 5. In operation, the RFIC 122 receives the RF signal 106 from the various antenna elements of the antenna array 120 and converts at least a portion of the RF signal 106 into an analog optical signal. Additional details of the operations of the RFIC 122 are described herein.

The light-emitting device 128 may include any of a variety of devices, such as a light-emitting diode (LED), a laser diode, and/or an organic light-emitting diode (OLED). In implementations in which the light-emitting device 128 comprises an LED or an OLED, the LED or OLED may have a dynamic range between approximately 20 dB and approximately 50 dB, such as between approximately 30 dB and approximately 40 dB.

The BBIC 124 includes at least one light-receiving device 136 and at least one baseband modem 138. The light-receiving device 136 may include any one or more of a variety of photodetectors that can receive an optical signal and convert the optical signal to an electrical signal (e.g., a photodiode, an LED, or a phototransistor). The baseband modem 138 may be implemented as a system on-chip (SoC) that provides a digital communication interface for data, voice, messaging, and other applications of the electronic device 102. The baseband modem 138 may also include baseband circuitry to perform high-rate sampling processes that can include analog-to-digital conversion (ADC), digital-to-analog conversion (DAC), gain correction, skew correction, frequency translation, and so forth.

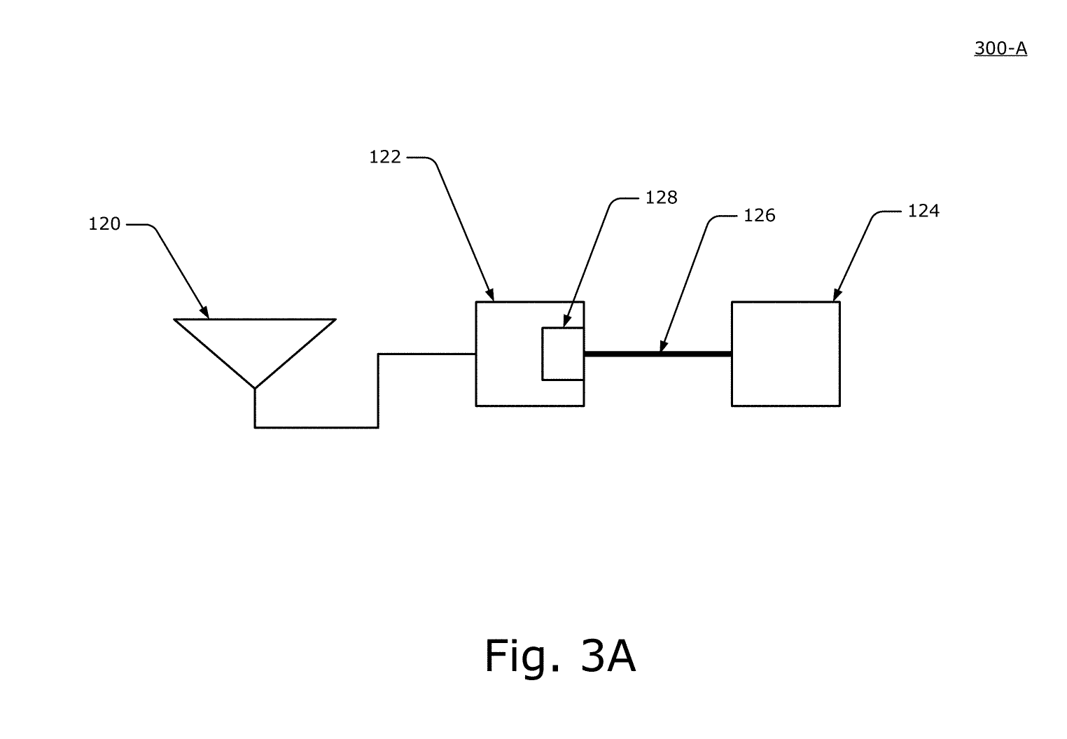

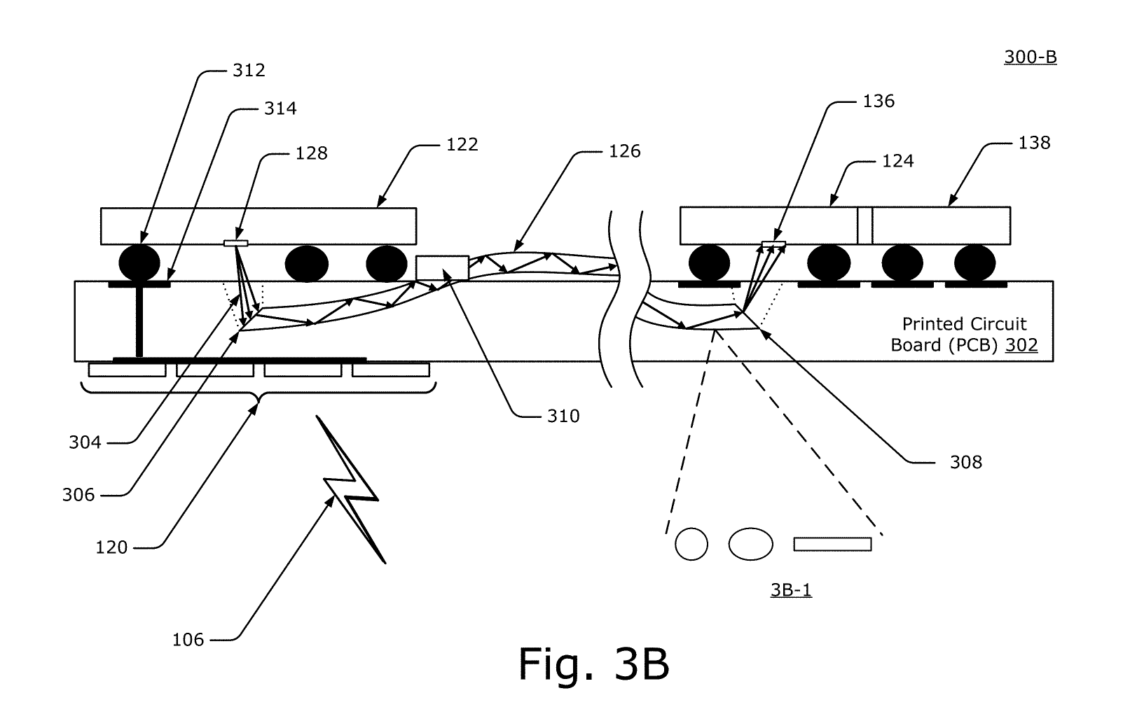

In some cases, components of the electronic device 102 are implemented on a single substrate, such as a printed circuit board (PCB) that can be formed from a rigid or flexible material to support components, circuits, and so forth. In other cases, various components may be implemented on separate substrates that are electronically coupled to one another. Example operations of, and interactions between, the RFIC 122 and the BBIC 124 are described with reference to FIGS. 3-7.

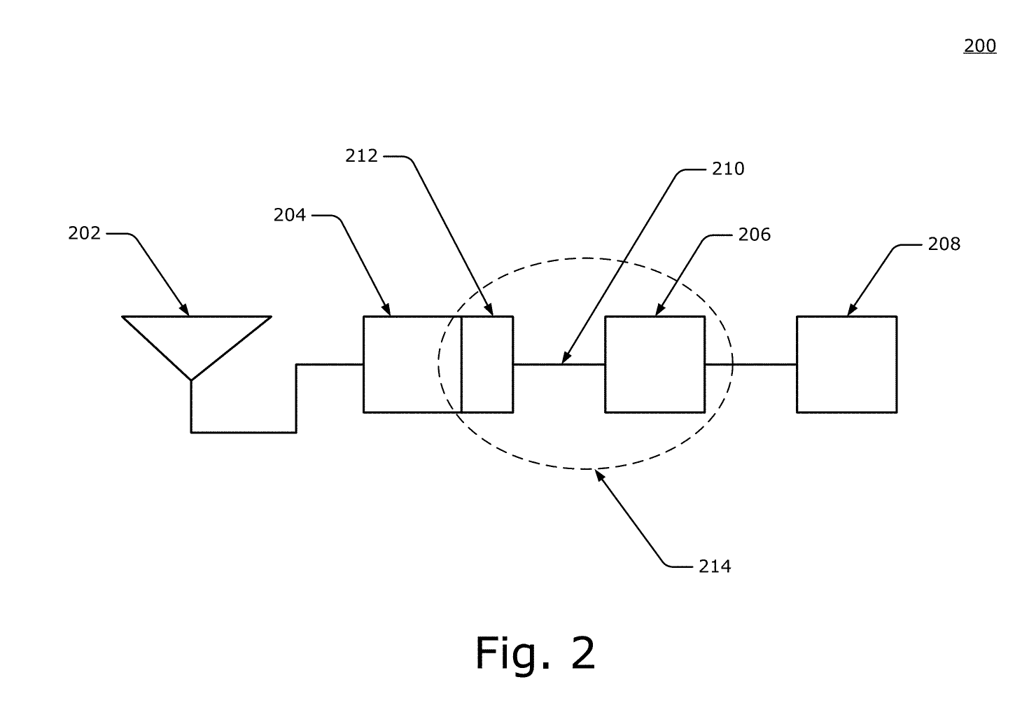

FIG. 2 illustrates a conventional mmW radio frequency system 200 as a simplified block diagram. The conventional system includes an antenna array 202, a conventional radio frequency integrated circuit (conventional RFIC) 204, an intermediate frequency integrated circuit (IFIC) 206, and a conventional baseband integrated circuit (conventional BBIC) 208. The conventional RFIC 204 and the IFIC 206 are connected via an intermediate frequency (IF) cable 210. The conventional RFIC 204 includes low-noise amplifiers, phase shifters, and mixers. The conventional RFIC 204, however, also includes a downconverter circuit 212 that downconverts the mmW signal to an IFIC frequency (e.g., from 28 GHz to 7 GHz or from 39 GHz to 10 GHz) for transmission of an IF signal over the IF cable 210 to the IFIC 206. Although not depicted in FIG. 2, the IFIC 206 includes a buffer circuit to amplify the IF signal and a downconverter circuit to convert the IF signal to a BB signal.

In contrast with systems that employ one or more IF-related components, an example RF communication system that includes an optical transceiver for RF communication as described herein is depicted in FIG. 3A. By using a system such as that illustrated in FIG. 3A, the downconverter circuit 212, the IFIC 206, and the IF cable 210 (as shown inside the ellipse 214 of FIG. 2) may be replaced or omitted. For example these components can be replaced with the light-emitting device 128 and the fiber optic cable 126 as described below with reference to FIG. 3A. These replacements reduce the number of components, along with their associated costs, and cut the risk of EM interference created by employing an IF cable. The risk of EM interference can be reduced without significant performance degradation, especially for implementations in which the fiber optic cable 126 is below some threshold length (e.g., less than about 15 meters, such as less than 10 meters, long).

FIG. 3A illustrates, as a simplified block diagram, an example RF communication system 300-A that includes an optical transceiver for radio frequency communication, as described herein. From left to right, the system includes the antenna array 120, the RFIC 122 (including the light-emitting device 128), the fiber optic cable 126, and the BBIC 124. Although not shown in FIG. 3A, the RFIC 122 can also include, for respective antenna elements of the antenna array 120, the LNA 130, the phase shifter 132, and the I/O amplifier 134, as described with reference to FIG. 1.

By converting a mmW RF signal to an analog optical signal and propagating the analog optical signal via the light-emitting device 128 and the fiber optic cable 126, the electronic device 102 can employ mmW radio frequency communication while reducing cost and power consumption. Further, using an analog optical signal and a fiber optic cable reduces EM interference often associated with conventional implementations of mmW communication systems that include intermediate frequency components and cables.

FIG. 3B illustrates an example implementation 300-B of an optical transceiver for radio frequency communication. The example implementation 300-B includes the antenna array 120, the RFIC 122, the BBIC 124, and the fiber optic cable 126. In the example implementation 300-B, these components are secured to, such as by being mounted on, a printed circuit board (PCB) 302. The antenna array 120 is coupled to the RFIC 122 so that the RFIC 122 can receive from the antenna array 120 an RF signal 106, such as a mmW RF signal (e.g., an RF signal having a frequency between approximately 20 GHz and approximately 90 GHz).

The RFIC 122 includes the light-emitting device 128, which is disposed on a surface of the RFIC 122, with the surface being on a side that faces the PCB 302. The light-emitting device 128 may be mounted on the surface of the RFIC 122 or integrated with the RFIC 122 during manufacturing of the RFIC 122. The light-emitting device 128 emits a modulated optical signal 304 that is modulated responsive to the RF signal 106. The modulated optical signal 304 can be an analog optical signal (e.g., the intensity of the modulated optical signal 304 varies directly with the frequency of the signal from the mmW antenna modules). As described above, the RF signal 106 is associated with a radio frequency and may be, for example, a mmW signal.

In some implementations, the RFIC 122 can control the light-emitting device 128 to modulate the modulated analog optical signal 304 at the radio frequency. For example, the RFIC 122 may modulate the modulated analog optical signal 304 at the radio frequency by changing a current flowing through the light-emitting device 128 in response to the RF signal 106. In other cases, the RFIC 122 may modulate the modulated analog optical signal 304 at the radio frequency by changing an intensity of the modulated analog optical signal 304 emitted by the light-emitting device 128 in response to the RF signal 106. Additionally or alternatively, other encoding methods may be used, such as orthogonal frequency-division multiplexing (OFDM). In still other implementations, the light-emitting device 128 may emit a modulated digital optical signal.

In the example implementation 300-B, the fiber optic cable 126 propagates the modulated analog optical signal 304. As shown, a first end 306 of the fiber optic cable 126 is disposed proximate to the light-emitting device 128 of the RFIC 122, and a second end 308 of the fiber optic cable 126 is disposed proximate to the light-receiving device 136 of the BBIC 124. The fiber optic cable 126 is positioned between the surface of the RFIC 122 on which the light-emitting device 128 is disposed and a surface of the PCB 302. The light-emitting device 128 can emit the modulated analog optical signal 304 such that the modulated analog optical signal 304 is directed to the first end 306 of the fiber optic cable 126 at an angle that causes the modulated analog optical signal 304 to propagate along the fiber optic cable 126 and exit from the second end 308 of the fiber optic cable 126 at an angle that causes the modulated analog optical signal 304 to be received by the light-receiving device 136 of the BBIC 124.

In other implementations, the antenna array 120 may include multiple antenna elements that can receive signals at different frequencies. In this case, the RF signal 106 received from the antenna array 120 can include two or more signals with different frequencies (e.g., a 28 GHz signal and a 39 GHz signal). As noted above, the RFIC 122 may include multiple light-emitting devices. For example, the light-emitting device 128 may include two LEDs (e.g., having different band gaps that emit at different wave lengths) that are electrically connected in a parallel configuration. One LED can thus emit an analog optical signal modulated in response to the 28 GHz signal, and the other LED can emit another analog optical signal modulated in response to the 39 GHz signal. The two LEDs are positioned such that the two optical signals are directed to the first end 306 of the fiber optic cable 126 at the RFIC 122 at one or more angles that enable the two modulated optical signals to propagate along the fiber optic cable 126.

Still other implementations may include additional LEDs, (or other types of light-emitting devices) connected in parallel, that can direct modulated analog optical signals 304 of different wavelengths (e.g., red, green, and blue LEDs) along the same or a separate fiber optic cable 126 to enable multiplexing of modulated analog optical signals along the fiber optic cable 126.

The light-emitting device 128, as shown in FIG. 3B, directs the modulated analog optical signal 304 to the first end 306 of the fiber optic cable 126 across an air gap located between the light-emitting device 128 and the first end 306 of the fiber optic cable 126. Similarly, the modulated analog optical signal 304 exits from the second end 308 of the fiber optic cable 126, travels across a corresponding air gap, and then is incident on the light-receiving device 136. In some implementations, the light-emitting device 128 can direct the modulated optical signal 304 across the air gap without propagating through a mechanical coupling device (e.g., an optical connector). In other cases, one or both ends of the fiber optic cable 126 may be terminated with a coupling device and/or either or both of the light-emitting device 128 and the light-receiving device 136 may include a mechanical optical coupling device.

As shown in FIG. 3B, the fiber optic cable 126 can be implemented as a discrete cable that is at least partially embedded in the PCB 302 and secured to a surface of the PCB 302 with a cable bracket 310. In other implementations, the fiber optic cable 126 may comprise a tube, a pipe, or a strip that can propagate an optical signal along a length of the fiber optic cable 126. For example, the fiber optic cable 126 may include a flat strip (e.g., a ribbon or tape) that is mounted on the surface of the PCB 302 or a rectangular pipe that can be inserted into a groove on the PCB 302. The ends of the fiber optic cable 126 are disposed at or near the surface of the PCB 302 to provide a coupling interface between the respective ends of the fiber optic cable 126 and the light-emitting device 128 and/or the light-receiving device 136. Example cross-sectional shapes (circular, elliptical, and rectangular) are shown in detail view 3B-1, and other shapes may also be used. For example, the cross-section of the fiber optic cable 126 may be customized to a shape similar to a shape of an emitting surface of the light-emitting device 128 or a receiving surface of the light-receiving device 136, which may increase the efficiency of the optical coupling.

The antenna array 120, the RFIC 122, the BBIC 124, and the fiber optic cable 126 may be mounted on a single rigid or flexible PCB, as shown in FIG. 3B. In other implementations, however, the antenna array 120, the RFIC 122 or the BBIC 124 may be mounted on one or more separate substrates (e.g., separate rigid or flexible PCBs, such as PCBs that are formed from a glass epoxy or a flexible circuit material) that are communicatively coupled. The RFIC 122 and the BBIC 124 can be attached to the PCB 302 using a variety of technologies. For example, the RFIC 122 or the BBIC 124 may be implemented as respective flip-chip components that are connected to the PCB 302 via electrical connections created between one or more solder bumps 312 and corresponding bond pads 314.

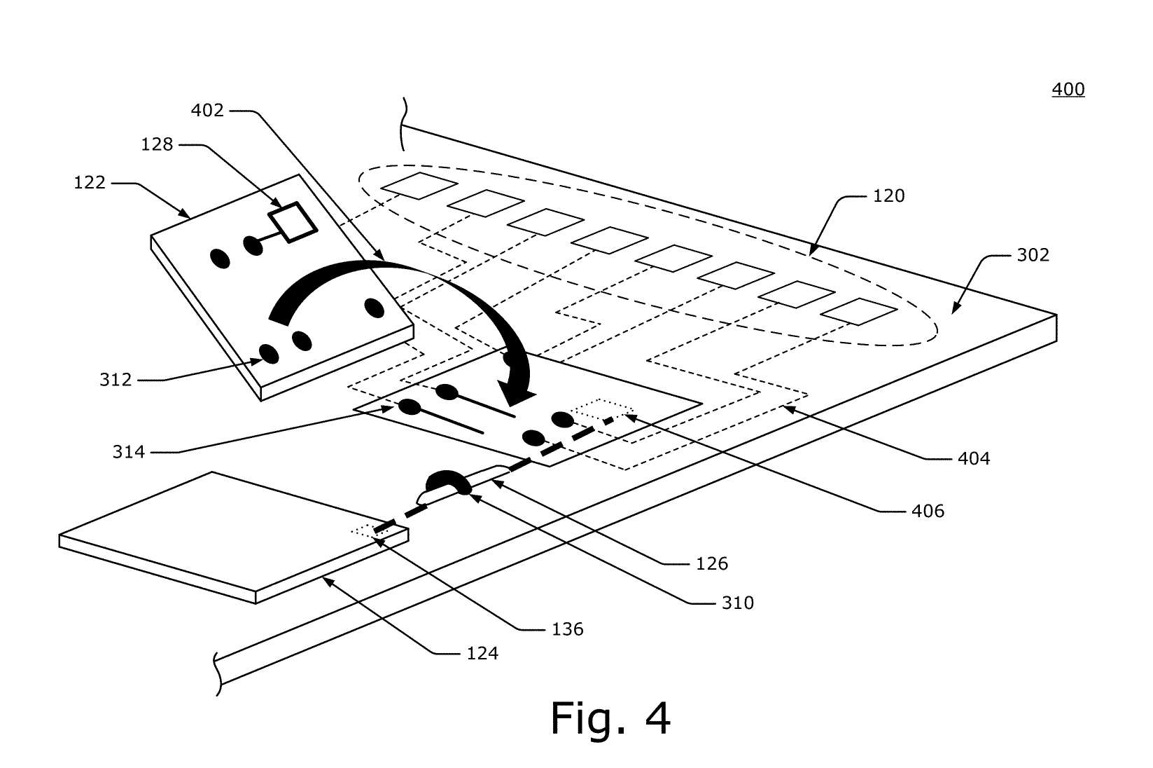

Consider FIG. 4, which illustrates generally at 400 additional details of the example implementation of the optical transceiver for radio frequency communication shown in FIG. 3B. In FIG. 4, a surface of the RFIC 122 includes the light-emitting device 128 and multiple solder bumps 312. The PCB 302 includes multiple bond pads 314. During the assembly process, as shown by the arrow 402, the RFIC 122 is flipped on to the PCB 302. When the RFIC 122 is flipped, the light-emitting device 128 aligns over an opening 406 that exposes the fiber optic cable 126 (e.g., at the first end 306), and the solder bumps 312 contact the corresponding bond pads 314. The solder bumps 312 are melted to form respective electrical connections with the bond pads 314 and thereby form electrical connections between the various components mounted to the PCB 302.

Conductive traces 404 can be used to make additional connections between and among components (e.g., between the antenna array 120 and the RFIC 122 (including the light-emitting device 128)). For clarity, FIG. 4 does not show the traces 404 as making every individual connection between the elements of the antenna array 120 and the bond pads 314. The fiber optic cable 126 is shown, as described above with reference to FIG. 3B, extending between the light-emitting device 128 and the light-receiving device 136. A portion of the fiber optic cable 126 that is embedded in the PCB 302 under the RFIC 122 and under the BBIC 124 (e.g., as in FIG. 3B) is shown in FIG. 4 as a dashed line. Another portion of the fiber optic cable 126 is shown in FIG. 4 on the surface of the PCB 302, secured by the cable bracket 310.

Alternatively or additionally, the RFIC 122 and/or the BBIC 124 may be manufactured using other technologies, such as wire bonding. The RFIC 122 and/or the BBIC 124 may also be made in other formats, such as a quad-flat package (QFP), a dual inline package (DIP), or a dual in-line pin package (DIPP).

FIG. 5 illustrates generally at 500 an example of circuitry for implementation of an optical transceiver for radio frequency communication. Specifically, examples of circuitry for the RFIC 122 and the BBIC 124 are shown. As illustrated, RFIC 122 includes, for each respective antenna element of the antenna array 120, an LNA 130, a phase shifter 132, and an I/O amplifier 134. The RF signal (e.g., a mmW signal at 28 GHz or 39 GHz) is received through the antenna array 120. The respective antenna elements of the antenna array 120 are coupled to the LNA 130, which amplifies the received RF signal. The amplified RF signal is routed through the phase shifter 132. The shifted signals from the antenna elements are combined, and the combined RF signal 502 is amplified by the I/O amplifier 134 and provided to the light-emitting device 128. The combined RF signal 502 drives the light-emitting device 128 to produce an optical signal, such as the modulated analog optical signal 304.

The modulated analog optical signal 304 propagates along the fiber optic cable 126 and is received at the light-receiving device 136, as described herein. The light-receiving device 136 converts the modulated analog optical signal 304 to an electrical signal 504. An amplification circuit 506 amplifies the electrical signal 504. A downconverting circuit 508 receives the amplified electrical signal and modulates the amplified electrical signal to a baseband frequency. The downconverting circuit 508 provides the modulated baseband signal to the baseband modem 138.

As shown in FIG. 5, the example circuitry for the RFIC 122 and the example circuitry for the BBIC 124 are designed to allow the components to operate in either or both of a transmit mode and a receive mode to implement the optical transceiver for radio frequency communication. For example, as shown at detail view 510, the BBIC 124 may also include another light-emitting device (e.g., analogous to the light-emitting device 128) and other components that the BBIC 124 can use to receive an electrical signal from the baseband modem 138 and convert the electrical signal to an optical signal that can be propagated along another fiber optic cable (with other first and second ends) to the RFIC 122. Similarly, as shown in the detail view 510, the RFIC 122 may also include another light-receiving device (e.g., like the light-receiving device 136) and other components, such as amplifiers and filters, that the RFIC 122 can use to receive another optical signal sent from the BBIC 124 and convert the other optical signal to a mmW RF signal that can be transmitted by the antenna array 120. In some implementations, the light-emitting devices and the light-receiving devices may work jointly as a system that can convert an electrical signal to an optical signal and convert an optical signal to an electrical signal. In these implementations, other components may also be included, such as silicon-based couplers (e.g., integrated with the RFIC 122 and/or the BBIC 124).

In still other implementations, a bidirectional fiber optic cable may be used to propagate signals from the RFIC 122 to the BBIC 124 and from the BBIC 124 to the RFIC 122. In some cases of this implementation, both the RFIC 122 and the BBIC 124 may include a light-emitting device and a light-receiving device (e.g., the light-emitting device 128 and the light-receiving device 136). In other cases, both the RFIC 122 and the BBIC 124 may include a device or system that can perform the functions of the light-emitting device 128 and the light-receiving device 136 (e.g., an LED configured as a photodiode or a combination of photodiodes and LEDs integrated with the RFIC 122 and the BBIC 124).

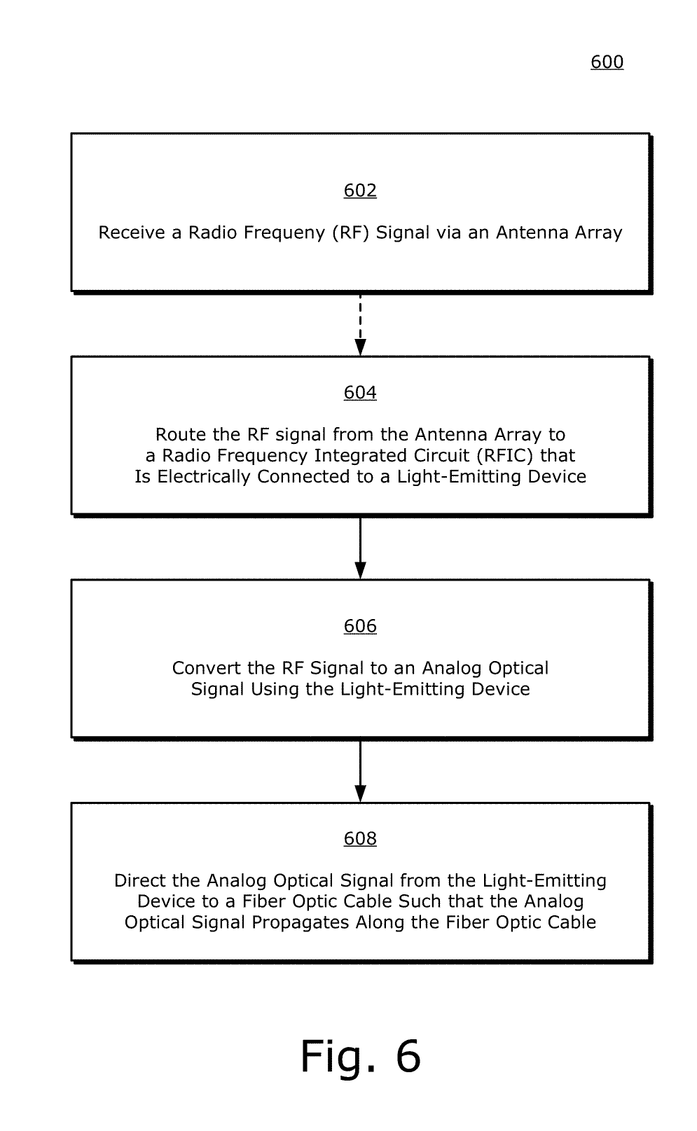

FIG. 6 is a flow diagram illustrating an example process 600 for operating an optical transceiver for radio frequency communication. The process 600 is described in the form of a set of blocks 602-608 that specify operations that can be performed. However, operations are not necessarily limited to the order shown in FIG. 6 or described herein, for the operations may be implemented in alternative orders or in fully or partially overlapping manners. Operations represented by the illustrated blocks of the process 600 may be performed by a radio frequency integrated circuit that includes a light-emitting device, such as the RFIC 122 described herein. More specifically, the operations of the process 600 may be performed by the components illustrated in FIG. 3-5, including the antenna array 120, which can send and receive mmW RF signals. The operations below are described in terms of handling a mmW RF signal that is received by the antenna array 120, but analogous operations may also be implemented in the reverse to handle a mmW RF signal that is transmitted by the antenna array 120.

At block 602, an antenna array receives an RF signal. For example, an antenna array 120 can receive one or more mmW signals (e.g., an RF signal with a frequency of 28 GHz or 60 GHz).

At block 604, the RF signal is routed to a radio frequency integrated circuit (RFIC) that includes a light-emitting device. For example, the RF signal may be routed to the RFIC 122, which includes the light-emitting device 128. As noted, the light-emitting device 128 is electrically connected to the RFIC 122 (e.g., integrated with the RFIC 122 or secured to the RFIC 122 in an electrically conductive manner).

At block 606, the RF signal is converted to an analog optical signal using the light-emitting device. For example, the light-emitting device 128 can emit an analog optical signal, such as the modulated analog optical signal 304. As noted, the modulated analog optical signal 304 can be modulated responsive to the RF signal and may be an analog optical signal (e.g., the intensity of the modulated optical signal 304 varies directly with the frequency of the signal from the mmW antenna modules).

In some cases, the RFIC 122 may be used to control the light-emitting device 128 to modulate the modulated analog optical signal 304 at the radio frequency of the RF signal. For example, the RFIC 122 may modulate the modulated analog optical signal 304 at the radio frequency by changing a current flowing through the light-emitting device 128 in response to the RF signal. In other cases, the RFIC 122 may modulate the analog optical signal 304 at the radio frequency by changing an intensity of the analog optical signal 304 emitted by the light-emitting device 128 in response to the RF signal.

At block 608, the modulated analog optical signal is directed from the light-emitting device to a fiber optic cable such that the analog optical signal propagates along the fiber optic cable. For example, a first end 306 of the fiber optic cable 126 can be disposed proximate to the light-emitting device 128 of the RFIC 122. The light-emitting device 128 emits the modulated analog optical signal 304 such that the modulated analog optical signal 304 is directed to the first end 306 of the fiber optic cable 126 at one or more angles (e.g., angles of incidence) that cause the modulated analog optical signal 304 to propagate along the fiber optic cable 126.

The modulated analog optical signal 304 may emit from the light-emitting device 128, propagate across an air gap, and may be incident on the fiber optic cable 126. The angles of incidence may be determined in a variety of manners. For example, the angles of incidence may be determined by one or more of the geometry of the light-emitting device 128, the geometry of the first end 306 of the fiber optic cable 126, the position or orientation of the light-emitting device 128, and the position of the first end 306 of the fiber optic cable 126, or the RFIC 122 may include a controller and/or additional hardware that can be used to control the angles of incidence (e.g., a controller may control a focal point of a lens that is disposed between the light-emitting device 128 and the fiber optic cable 126). In some cases, the light-emitting device 128 can direct the modulated analog optical signal 304 across the air gap without propagating through a mechanical coupling device (e.g., without an optical connector) connected to either or both of the light-emitting device 128 or the first end 306 of the fiber optic cable 126. In other cases, the fiber optic cable 126 and/or the light-emitting device 128 may include an optical connector that enables the propagation with or without an air gap.

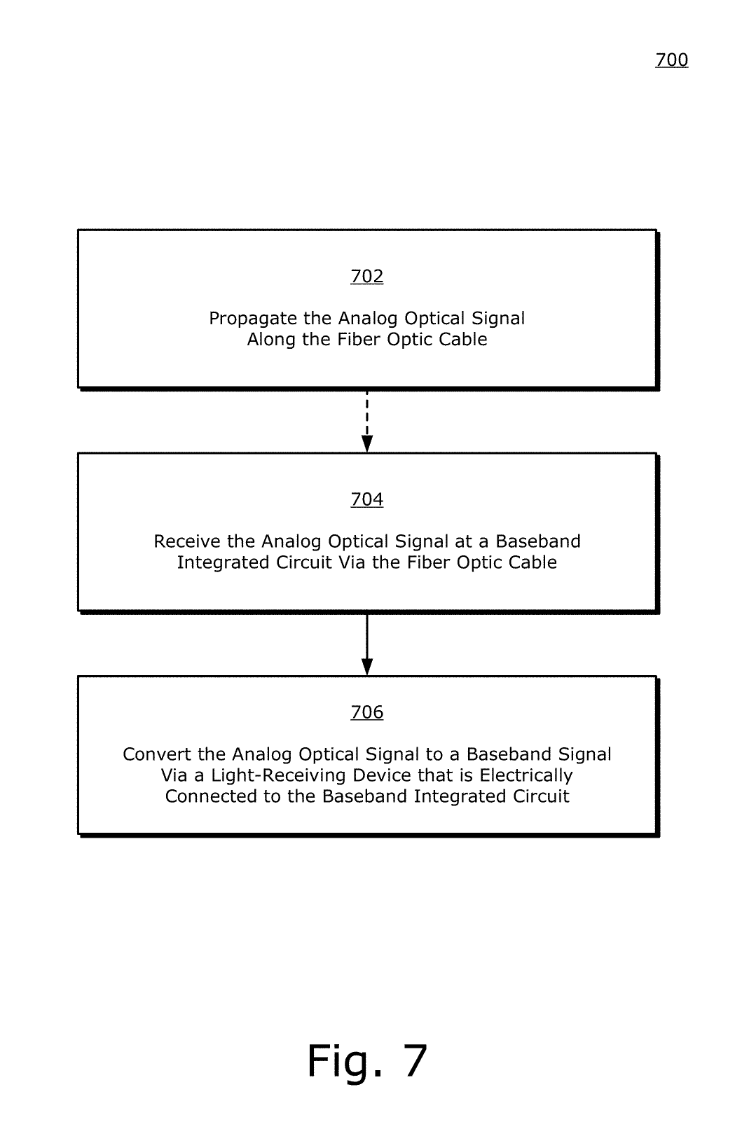

FIG. 7 is a flow diagram that illustrates additional details 700 of the example process 600 shown in FIG. 6. At block 702, the analog optical signal is propagated along the fiber optic cable. For example, the modulated analog optical signal 304 may be propagated along the fiber optic cable 126.

At block 704, the analog optical signal is received at a baseband integrated circuit via the fiber optic cable. For example, the second end 308 of the fiber optic cable 126 can be disposed proximate to the light-receiving device 136 of the BBIC 124. In this example, the fiber optic cable 126 is positioned to cause the modulated analog optical signal 304 to exit from the second end 308 of the fiber optic cable 126 at one or more angles (e.g., angles of incidence) that cause the light-receiving device 136 of the BBIC 124 to receive the modulated analog optical signal 304. Similar to the process described with reference to block 608 of FIG. 6, the modulated optical signal 304 may exit from the second end 308 of the fiber optic cable 126 to the light-receiving device 136 across an air gap without propagating through a mechanical coupling device (e.g., without an optical connector) connected to either or both of the light-receiving device 136 or the fiber optic cable 126. In other cases, the fiber optic cable 126 and/or the light-receiving device 136 may include an optical connector that enables the propagation with or without an air gap.

At block 706 the analog optical signal is converted to a baseband signal via a light-receiving device that is electrically connected to the baseband integrated circuit. Continuing the example above, the modulated analog optical signal 304 may be received by one or more of the light-receiving devices 136 of the BBIC 124 (e.g., a photodiode, an LED, or a phototransistor) that can convert the modulated analog optical signal 304 to an electrical signal, which is then converted to a baseband signal as described herein.

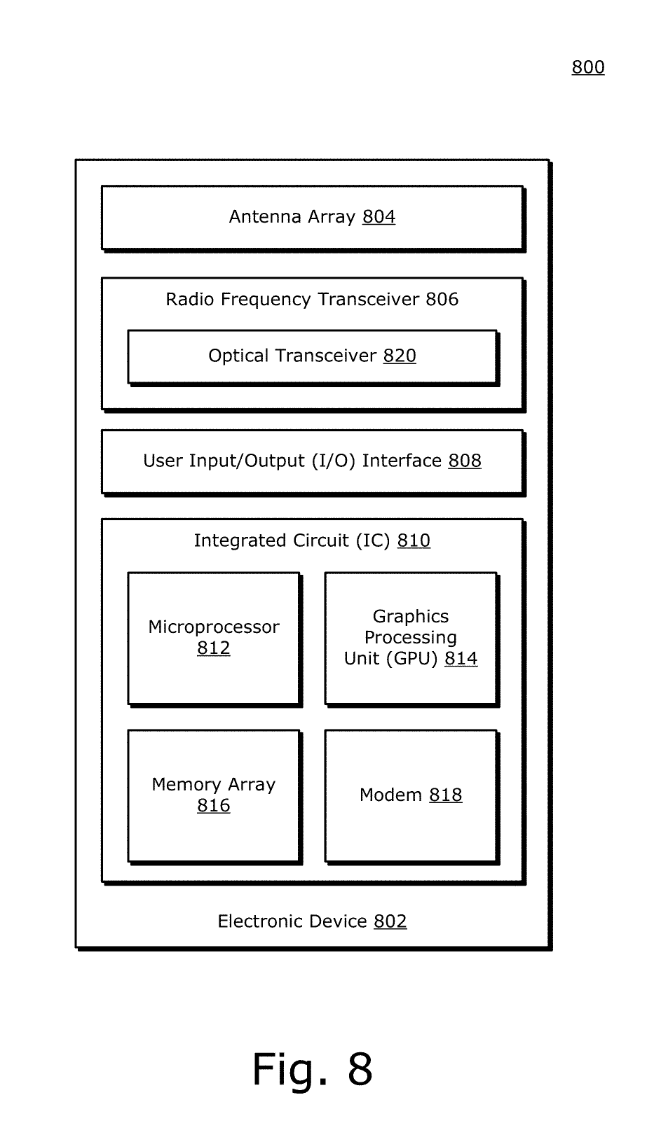

FIG. 8 illustrates generally at 800 an example electronic device 802 that includes one or more integrated circuits in which an optical transceiver for radio frequency communication can be implemented. As shown, the electronic device 802 includes an antenna array 804, a radio frequency (RF) transceiver 806, a user input/output (I/O) interface 808, and an integrated circuit (IC) 810 having multiple cores. Illustrated examples of the IC 810, or cores thereof, include a microprocessor 812, a graphics processing unit (GPU) 814, a memory array 816, and a modem 818. In one or more example implementations, an optical transceiver 820 for radio frequency communication as described herein (including, for example, the RFIC 122, the BBIC 124, and/or the fiber optic cable 126) can be implemented in the electronic device 802, such as with the RF transceiver 806 and/or the IC 810. Thus, the electronic device 802 can communicate using mmW RF signals with fewer components and reduced risk of EM interference as compared to conventional approaches.

The electronic device 802 can be a mobile or battery-powered device or a fixed device that is designed to be powered by an electrical grid. Examples of the electronic device 802 include a server computer, a network switch or router, a blade of a data center, a personal computer, a desktop computer, a notebook or laptop computer, a tablet computer, a smart phone, an entertainment appliance, a display device such as a television or monitor, or a wearable computing device such as a smartwatch, intelligent glasses, or an article of clothing. An electronic device 802 can also be a device, or a portion thereof, having embedded electronics. Examples of the electronic device 802 with embedded electronics include a passenger vehicle, industrial equipment, a refrigerator or other home appliance, a drone or other unmanned aerial vehicle (UAV), or a power tool.

For an electronic device with a wireless capability, the electronic device 802 includes an antenna array 804 that is coupled to the RF transceiver 806 to enable reception or transmission of one or more wireless signals. The IC 810 may be coupled to the RF transceiver 806 to enable the IC 810 to have access to received wireless signals or to provide wireless signals for transmission via the antenna array 804. The electronic device 802 as shown also includes at least one user I/O interface 808. Examples of the user I/O interface 808 include a keyboard, a mouse, a microphone, a touch-sensitive screen, a camera, an accelerometer, a haptic mechanism, a speaker, a display screen, or a projector. The RF transceiver 806 can correspond to, for example, the RFIC 122 and the BBIC 124 (e.g., of FIGS. 1 and 3A-6) that implement an optical transceiver for radio frequency communication.

The IC 810 may comprise, for example, one or more instances of a microprocessor 812, a GPU 814, a memory array 816, a modem 818, and so forth. Alternatively or additionally, the IC 810 can correspond to, for example, the RFIC 122 or the BBIC 124 (e.g., of FIGS. 1 and 3A-6) that implement an optical transceiver for radio frequency communication.

The microprocessor 812 may function as a central processing unit (CPU) or other general-purpose processor. Some microprocessors include different parts, such as multiple processing cores, that may be individually powered on or off. The GPU 814 may be especially adapted to process visual-related data for display, such as video data images. If visual-related data is not being rendered or otherwise processed, the GPU 814 may be fully or partially powered down. The memory array 816 stores data for the microprocessor 812 or the GPU 814. Example types of memory for the memory array 816 include random access memory (RAM), such as dynamic RAM (DRAM) or static RAM (SRAM); flash memory; and so forth. If programs are not accessing data stored in memory, the memory array 816 may be powered down overall or block-by-block. The modem 818 demodulates a signal to extract encoded information or modulates a signal to encode information into the signal. If there is no information to decode from an inbound communication or to encode for an outbound communication, the modem 818 may be idled to reduce power consumption. The IC 810 may include additional or alternative parts than those that are shown, such as an I/O interface, a sensor such as an accelerometer, a transceiver or another part of a receiver chain, a customized or hard-coded processor such as an application-specific integrated circuit (ASIC), and so forth.

The IC 810 may also comprise a system on a chip (SOC). An SOC may integrate a sufficient number of different types of components to enable the SOC to provide computational functionality as a notebook computer, a mobile phone, or another electronic apparatus using one chip, at least primarily. Components of an SOC, or an IC 810 generally, may be termed cores or circuit blocks. Examples of cores or circuit blocks include, in addition to those that are illustrated in FIG. 8, a voltage regulator, a main memory or cache memory block, a memory controller, a general-purpose processor, a cryptographic processor, a video or image processor, a vector processor, a radio, an interface or communications subsystem, a wireless controller, or a display controller. Any of these cores or circuit blocks, such as a central processing unit or a multimedia processor, may further include multiple internal cores or circuit blocks.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

1. An apparatus, comprising:
an antenna array;
a radio frequency integrated circuit (RFIC) that is coupled to the antenna array and mounted to a printed circuit board (PCB), the RFIC including a surface that faces the PCB and configured to receive a radio frequency (RF) signal from the antenna array;
a baseband integrated circuit that includes a light-receiving device;
a fiber optic cable having a first end disposed proximate to the RFIC and a second end disposed proximate to the light-receiving device, at least a portion of the fiber optic cable secured to the PCB; and
a light-emitting device disposed on the surface that faces the PCB, the light-emitting device configured to emit an optical signal that is modulated responsive to the RF signal and direct the modulated optical signal to the first end of the fiber optic cable so as to cause the modulated optical signal to propagate along the fiber optic cable to be received by the light receiving device.

2. The apparatus of claim 1, wherein the light-emitting device comprises a light-emitting diode (LED).

3. The apparatus of claim 1, wherein the light-emitting device is disposed on the surface of the RFIC by being integrated with the RFIC.

4. The apparatus of claim 1, wherein the modulated optical signal comprises an analog optical signal.

5. The apparatus of claim 1, further comprising:
another light-receiving device, the other light-receiving device included with the RFIC;
another fiber optic cable having another first end disposed proximate to the baseband integrated circuit and another second end disposed proximate to the other light-receiving device, at least a portion of the other fiber optic cable secured to the PCB; and
another light-emitting device, the other light-emitting device included with the baseband integrated circuit and configured to emit another optical signal that is modulated responsive to an electrical signal received from the baseband integrated circuit and direct the other modulated optical signal to the other first end of the other fiber optic cable so as to cause the other modulated optical signal to:
propagate along the other fiber optic cable; and
exit from the other second end of the other fiber optic cable at an angle that causes the other modulated optical signal to be received by the other light-receiving device.

6. The apparatus of claim 4, wherein:
the RF signal is associated with a radio frequency; and
the RFIC is configured to control the light-emitting device to modulate the analog optical signal at the radio frequency.

7. The apparatus of claim 6, wherein the RFIC is configured to modulate the analog optical signal at the radio frequency by at least one of:
changing a current flowing through the light-emitting device responsive to the RF signal; or
changing an intensity of the analog optical signal emitted by the light-emitting device responsive to the RF signal.

8. The apparatus of claim 1 wherein:
the RF signal comprises a first RF signal and a second RF signal; and
the light-emitting device comprises:
a first light-emitting diode (LED) configured to emit a first analog optical signal modulated responsive to the first RF signal; and
a second LED that is electrically connected to the first LED in a parallel configuration, the second LED configured to emit a second analog optical signal modulated responsive to the second RF signal,
wherein the first LED and the second LED are configured to direct the first analog optical signal and the second analog optical signal, respectively, to the first end of the fiber optic cable to propagate the first and second analog optical signals along the fiber optic cable.

9. The apparatus of claim 1, wherein the RF signal comprises a millimeter-wave (mmW) signal having a frequency between approximately 20 GHz and approximately 90 GHz.

10. The apparatus of claim 1, wherein the light-emitting device is further configured to direct the modulated optical signal to the first end of the fiber optic cable across an air gap located between the light-emitting device and the first end of the fiber optic cable.

11. The apparatus of claim 10, wherein the light-emitting device is further configured to direct the modulated optical signal across the air gap without propagating through a mechanical coupling device.

12. The apparatus of claim 1, wherein the fiber optic cable comprises at least one of a tube, a pipe, or a strip that is configured to propagate the modulated optical signal along a length of the fiber optic cable.

13. The apparatus of claim 1, wherein the fiber optic cable is positioned between the surface of the RFIC on which the light-emitting device is disposed and a surface of the PCB.

14. The apparatus of claim 1, wherein the light-emitting device comprises a laser diode.

15. An apparatus, comprising:
an antenna array;
a printed circuit board (PCB);
a fiber optic cable, at least a portion of the fiber optic cable secured to the PCB; and
a radio frequency integrated circuit (RFIC) that is coupled to the antenna array and mounted to the PCB, the RFIC:
configured to receive a radio frequency (RF) signal from the antenna array;
including a surface that faces the PCB; and
including a light-emitting device disposed on the surface that faces the PCB, the light-emitting device configured to:
emit an optical signal that is modulated responsive to the RF signal; and
direct the modulated optical signal to the fiber optic cable to propagate along the fiber optic cable.

16. The apparatus of claim 15, wherein the light-emitting device comprises a light-emitting diode (LED).

17. The apparatus of claim 16, wherein the LED has a dynamic range between approximately 30 dB and approximately 40 dB.

18. The apparatus of claim 15, wherein the modulated optical signal comprises an analog optical signal.

19. The apparatus of claim 18, wherein:
the RF signal is associated with a radio frequency; and
the RFIC is configured to control the light-emitting device to modulate the analog optical signal at the radio frequency.

20. The apparatus of claim 19, wherein the RFIC is configured to control the light-emitting device to modulate the analog optical signal at the radio frequency by at least one of:
a change of a current flowing through the light-emitting device responsive to the RF signal; or
a change of an intensity of the analog optical signal emitted by the light-emitting device responsive to the RF signal.

21. A method for operating an optical transceiver for radio frequency (RF) communication, the method comprising:
receiving an RF signal via an antenna array;
routing the RF signal from the antenna array to a radio frequency integrated circuit (RFIC) that is electrically connected to a light-emitting device;
converting, using the light-emitting device, the RF signal to an analog optical signal; and
directing the analog optical signal from the light-emitting device to a fiber optic cable such that the analog optical signal propagates along the fiber optic cable.

22. The method of claim 21, wherein the light-emitting device is a light-emitting diode (LED).

23. The method of claim 21, wherein the converting the RF signal to the analog optical signal comprises modulating the analog optical signal by at least one of:
a current flowing through the light-emitting device responsive to the RF signal to produce a modulated analog optical signal; or
changing an intensity of the analog optical signal responsive to the RF signal to produce a modulated analog optical signal.

24. The method of claim 23, wherein the directing comprises emitting the modulated analog optical signal as light from the light-emitting device, across an air gap, to the fiber optic cable effective to cause the modulated analog optical signal to propagate along the fiber optic cable.

25. The method of claim 21, wherein the fiber optic cable comprises a bidirectional fiber optic cable.

26. The method of claim 21, further comprising:
propagating the analog optical signal along the fiber optic cable;
receiving the analog optical signal at a baseband integrated circuit via the fiber optic cable; and
converting the analog optical signal to a baseband signal via a light-receiving device that is electrically connected to the baseband integrated circuit.

27. The method of claim 26, wherein:
the light-receiving device comprises a photodiode that is electrically connected to the baseband integrated circuit; and
the receiving the analog optical signal comprises receiving, by the photodiode, the analog optical signal as light that exits the fiber optic cable and travels across an air gap between the fiber optic cable and the photodiode.

28. An apparatus, comprising:
a printed circuit board (PCB);
an antenna array mounted to the PCB;
a fiber optic cable, at least a portion of the fiber optic cable secured to the PCB;
a radio frequency integrated circuit (RFIC) mounted to the PCB and coupled to the antenna array, the RFIC configured to receive a radio frequency (RF) signal from the antenna array, the RFIC including a surface that faces the PCB and a light-emitting device that is disposed on the surface, the light-emitting device configured to emit an optical signal that is modulated responsive to the RF signal; and
means for coupling the modulated optical signal between the light-emitting device and the fiber optic cable in a manner that causes the modulated optical signal to propagate along the fiber optic cable.

29. The apparatus of claim 28, wherein the modulated optical signal comprises an analog optical signal.

30. The apparatus of claim 28, wherein the light-emitting device comprises at least one of a light-emitting diode (LED) or a laser diode.
